(19) United States
(12) Patent Application Publication
(10) Pub. No.: US 2025/0173658 A1
(43) Pub. Date: May 29, 2025

(54) METHOD FOR PROVIDING SERVICES FOR ONE OR MORE PERSONS

(71) Applicant: BitHuman Inc, San Francisco, CA (US)

(72) Inventors: Yun Fu, Newton, MA (US); Steve Gu, Lafayette, CA (US)

(73) Assignee: BitHuman Inc, San Francisco, CA (US)

(21) Appl. No.: 18/523,872

(22) Filed: Nov. 29, 2023

(51) Int. Cl. G06Q 10/0637

(52) U.S. Cl. CPC G06Q 10/0637

(57) ABSTRACT

Embodiments of the present disclosure may include a method for providing services for one or more persons with an artificial intelligence system within an area, the method including setting a set of goals before conversations with a set of users.

### BACKGROUND OF THE INVENTION

Embodiments of the present disclosure may include a method for providing services for one or more persons with an artificial intelligence system within an area, the method including setting a set of goals before conversations with a set of users. The conversations may relate to any of the processes of meetings, sales, meditation, teaching, consulting, training, and mental health treatment.

### BRIEF SUMMARY

Embodiments of the present disclosure may include a method for providing services for one or more persons with an artificial intelligence system within an area, the method including setting a set of goals before conversations with a set of users. In some embodiments, the artificial intelligence system may include an artificial intelligence engine.

In some embodiments, an artificial intelligence engine may be configured to actively drive the conversations. In some embodiments, the set of goals may be related to the conversations. In some embodiments, the conversations may relate to any of processes of meetings, sales, meditation, teaching, consulting, training, and mental health treatment.

Embodiments may also include detecting, by one or more processors, the set of users in proximity with the artificial intelligence. In some embodiments, an artificial intelligence engine in the artificial intelligence system may be coupled to the one or more processors and a server. In some embodiments, the artificial intelligence engine may be trained by human experts in the field.

In some embodiments, a virtual agent may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the virtual agent. In some embodiments, the visual agent may be configured to be displayed with an appearance of a real human or a humanoid or a cartoon character.

In some embodiments, the virtual agent's gender, age and ethnicity may be determined by the artificial Intelligence engine's analysis on input from the set of users. In some embodiments, the visual agent may be configured to be displayed in full body or half body portrait mode. In some embodiments, the artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. In some embodiments, the visual agent may be configured to chat with multiple persons within the set of users simultaneously. In some embodiments, profile and chatting content of each person of the set of users may be configured to be recorded and memorized separately via a set of files in local or cloud databases.

In some embodiments, the chatting content of each person of the set of users may be configured to be categorized and labelled with different level of privacy. In some embodiments, the different level of privacy may be determined by the scenarios and the decisions of the each person who may be owner of the chatting content. In some embodiments, the system may update recorded memory for each person of the set of users instantly.

In some embodiments, the AI engine may be configured to use public contents cross the multiple persons of the set of users. In some embodiments, the AI engine may be configured to talk privately with a single user of the set of users when disclosing private level content. In some embodiments, the AI engine may be configured to ask permission from another user of the users during multiple-person conversation to disclose certain private contents.

In some embodiments, the AI engine may be configured to update the memory, recording, labels after each conversation for each identified user of the set of users. Embodiments may also include initiating conversations by stating general greetings for the set of users. Embodiments may also include asking a list of questions to the set of users.

In some embodiments, the list of questions may be customized for the set of users. Embodiments may also include detecting and tracking the set of users' face, eye, and pose by a set of outward-facing cameras coupled to the one or more processors. In some embodiments, a set of touch screens coupled to the one or more processors may be configured to allow the set of users to interact with the virtual agent by hand.

Embodiments may also include using the set of outward-facing cameras to capture users' status to evaluate engagement. Embodiments may also include and decide the response or trigger topics and contents of the conversations. Embodiments may also include receiving responses from the set of users. In some embodiments, the responses may include voice, facial expressions, body language, motion, poses and gestures.

Embodiments may also include analyzing the set of users' status. In some embodiments, the set of users' status may include psychological status, emotion, and insights. Embodiments may also include loading a corresponding file of the set of files for a particular person in the set of users when the system may be focusing on the particular person of the set of users.

In some embodiments, the AI engine may be configured to shift to another file of the set of files when the AI engine may be set to shift focus to a different person of the set of users. Embodiments may also include using tree-based or rule-based strategy to decide responses to the responses from the set of users. Embodiments may also include checking the completion status of the set of goals in real-time.

In some embodiments, if the set of goals may be not reached, the AI engine may be configured to continue the conversations. In some embodiments, if the set of goals may be reached, the AI engine may be configured to suggest to end the conversations. In some embodiments, if the set of users' responses may be not positively driving, the AI engine may be configured to revise the set of goals during the conversation by mitigating the unsatisfied responses from the set of users.

Embodiments of the present disclosure may also include a method for providing services for one or more persons with an artificial intelligence system within an area, the method including setting a set of goals before conversations with a set of users. In some embodiments, the artificial intelligence system may include an artificial intelligence engine.

In some embodiments, an artificial intelligence engine may be configured to actively drive the conversations. In some embodiments, the set of goals may be related to the conversations. In some embodiments, the conversations may relate to any of processes of sales, meditation, teaching, consulting, training, and mental health treatment.

Embodiments may also include detecting, by one or more processors, the set of users in proximity with the artificial intelligence. In some embodiments, an artificial intelligence engine in the artificial intelligence system may be coupled to the one or more processors and a server. In some embodiments, the artificial intelligence engine may be trained by human experts in the field.

In some embodiments, a virtual agent may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the virtual agent. In some embodiments, the visual agent may be configured to chat with multiple persons within the set of users simultaneously.

In some embodiments, profile and chatting content of each person of the set of users may be configured to be recorded and memorized separately via a set of files in local or cloud databases. In some embodiments, the chatting content of each person of the set of users may be configured to be categorized and labelled with different level of privacy.

In some embodiments, the different level of privacy may be determined by the scenarios and the decisions of the each person who may be owner of the chatting content. In some embodiments, the system may update recorded memory for each person of the set of users instantly. In some embodiments, the AI engine may be configured to freely use public contents cross the multiple persons of the set of users.

In some embodiments, the AI engine may be configured to talk privately with a single user of the set of users when disclosing private level content. In some embodiments, the AI engine may be configured to ask permission from another user of the users during multiple-person conversation to disclose certain private contents. In some embodiments, the AI engine may be configured to update the memory, recording, labels after each conversation for each identified user of the set of users.

Embodiments may also include initiating conversations by stating general greetings for the set of users. Embodiments may also include asking a list of questions to the set of users. In some embodiments, the list of questions may be customized for the set of users. Embodiments may also include detecting and tracking the set of users' face, eye, and pose by a set of outward-facing cameras coupled to the one or more processors.

In some embodiments, a set of touch screens coupled to the one or more processors may be configured to allow the set of users to interact with the virtual agent by hand. Embodiments may also include using the set of outward-facing cameras to capture users' status to evaluate engagement. Embodiments may also include and decide the response or trigger topics and contents of the conversations.

Embodiments may also include receiving responses from the set of users. In some embodiments, the responses may include voice, facial expressions, sign language, motion, poses and gestures. Embodiments may also include analyzing the set of users' status. In some embodiments, the set of users' status may include psychological status, emotion, and insights.

Embodiments may also include loading a corresponding file of the set of files for a particular person in the set of users when the system may be focusing on the particular person of the set of users. In some embodiments, the AI engine may be configured to shift to another file of the set of files when the AI engine may be set to shift focus to a different person of the set of users.

Embodiments may also include checking the completion status of the set of goals in real-time. In some embodiments, if the set of goals may be not reached, the AI engine may be configured to continue the conversations. In some embodiments, if the set of goals may be reached, the AI engine may be configured to suggest to end the conversations. In some embodiments, if the set of users' responses may be not positively driving, the AI engine may be configured to revise the set of goals during the conversation by mitigating the unsatisfied responses from the set of users.

Embodiments of the present disclosure may also include a method for providing meeting services for one or more persons with an artificial intelligence system within an area, the method including setting a set of goals before conversations with a set of users. In some embodiments, the artificial intelligence system may include an artificial intelligence engine.

In some embodiments, an artificial intelligence engine may be configured to actively drive the conversations. In some embodiments, the set of goals may be related to the conversations. In some embodiments, the conversations may relate to meetings. Embodiments may also include detecting, by one or more processors, the set of users in proximity with the artificial intelligence.

In some embodiments, an artificial intelligence engine in the artificial intelligence system may be coupled to the one or more processors and a server. In some embodiments, the artificial intelligence engine may be trained by human experts in the field. In some embodiments, a virtual agent may be configured to be displayed in LED/OLED displays, Android/iOS tablets, Laptops/PCs, smartphones, or VR/AR goggles.

In some embodiments, a set of multi-layer info panels coupled to the one or more processors may be configured to overlay graphics on top of the virtual agent. In some embodiments, the visual agent may be configured to chat with multiple persons within the set of users simultaneously. In some embodiments, profile and chatting content of each person of the set of users may be configured to be recorded and memorized separately via a set of files in local or cloud databases.

In some embodiments, the chatting content of each person of the set of users may be configured to be categorized and labelled with different level of privacy. In some embodiments, the different level of privacy may be determined by the scenarios and the decisions of the each person who may be owner of the chatting content. In some embodiments, the system may update recorded memory for each person of the set of users instantly.

In some embodiments, the AI engine may be configured to freely use public contents cross the multiple persons of the set of users. In some embodiments, the AI engine may be configured to talk privately with a single user of the set of users when disclosing private level content. In some embodiments, the AI engine may be configured to ask permission from another user of the users during multiple-person conversation to disclose certain private contents.

In some embodiments, the AI engine may be configured to update the memory, recording, labels after each conversation for each identified user of the set of users. Embodiments may also include initiating conversations by stating general greetings for the set of users. Embodiments may also include asking a list of questions to the set of users.

In some embodiments, the list of questions may be customized for the set of users. Embodiments may also include detecting and tracking the set of users' face, eye, and pose by a set of outward-facing cameras coupled to the one or more processors. In some embodiments, a set of touch screens coupled to the one or more processors may be configured to allow the set of users to interact with the virtual agent by hand.

Embodiments may also include receiving responses from the set of users. In some embodiments, the responses may include voice, facial expressions, sign language, motion, poses and gestures. Embodiments may also include analyzing the set of users' status. In some embodiments, the set of users' status may include psychological status, emotion, and insights.

Embodiments may also include loading a corresponding file of the set of files for a particular person in the set of users when the system may be focusing on the particular person of the set of users. In some embodiments, the AI engine may be configured to shift to another file of the set of files when the AI engine may be set to shift focus to a different person of the set of users.

Embodiments may also include checking the completion status of the set of goals in real-time. In some embodiments, if the set of goals may be not reached, the AI engine may be configured to continue the conversations. In some embodiments, if the set of goals may be reached, the AI engine may be configured to suggest to end the conversations. In some embodiments, if the set of users' responses may be not positively driving, the AI engine may be configured to revise the set of goals during the conversation by mitigating the unsatisfied responses from the set of users.

### BRIEF DESCRIPTION OF THE FIGURES

FIG. 1A is a flowchart illustrating a method for providing services for one or more persons, according to some embodiments of the present disclosure.

FIG. 1B is a flowchart extending from FIG. 1A and further illustrating the method for providing services for one or more persons, according to some embodiments of the present disclosure.

FIG. 2A is a flowchart illustrating a method for providing services for one or more persons, according to some embodiments of the present disclosure.

FIG. 2B is a flowchart extending from FIG. 2A and further illustrating the method for providing services for one or more persons, according to some embodiments of the present disclosure.

FIG. 3A is a flowchart illustrating a method for providing meeting services for one or more persons, according to some embodiments of the present disclosure.

FIG. 3B is a flowchart extending from FIG. 3A and further illustrating the method for providing meeting services for one or more persons, according to some embodiments of the present disclosure.

FIG. 4 is a diagram showing an example of a method for providing services for one or more persons, according to some embodiments of the present disclosure.

FIG. 5 is a diagram showing a second example of a method for providing services for one or more persons, according to some embodiments of the present disclosure.

FIG. 6 is a diagram showing a third example of a method for providing services for one or more persons, according to some embodiments of the present disclosure.

FIG. 7 is a diagram showing a fourth example of a method for providing services for one or more persons, according to some embodiments of the present disclosure.

FIG. 8 is a diagram showing a fifth example of a method for providing services for one or more persons, according to some embodiments of the present disclosure.

FIG. 9 is a diagram showing a sixth example of a method for providing services for one or more persons, according to some embodiments of the present disclosure.

FIG. 10 is a diagram showing a seventh example of a method for providing services for one or more persons, according to some embodiments of the present disclosure.

### DETAILED DESCRIPTION

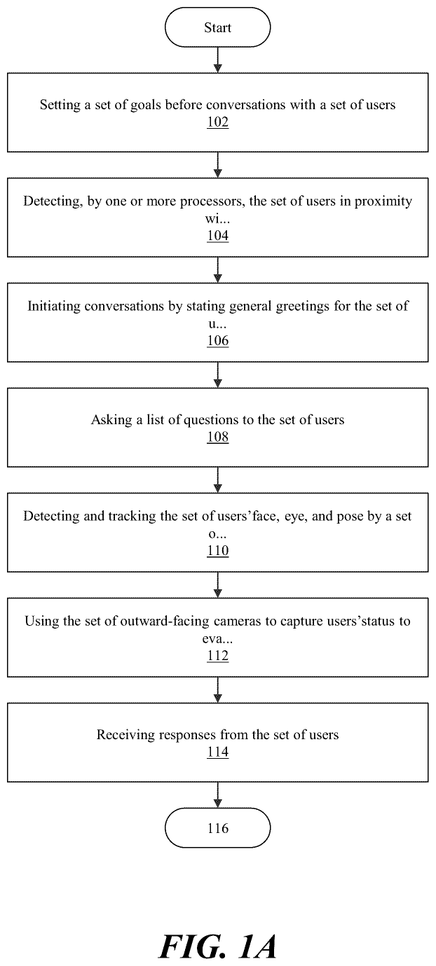

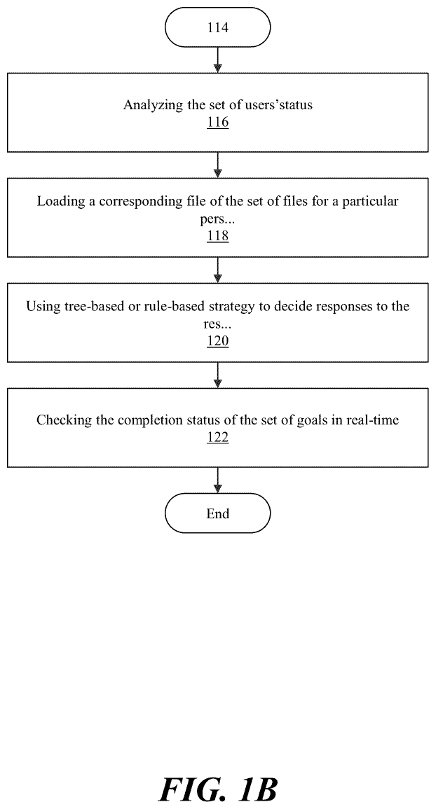

FIGS. 1A to 1B are flowcharts that describe a method for providing services for one or more persons, according to some embodiments of the present disclosure. In some embodiments, at 102, the method may include setting a set of goals before conversations with a set of users. At 104, the method may include detecting, by one or more processors, the set of users in proximity with the artificial intelligence. At 106, the method may include initiating conversations by stating general greetings for the set of users. At 108, the method may include asking a list of questions to the set of users.

In some embodiments, at 110, the method may include detecting and tracking the set of users' face, eye, and pose by a set of outward-facing cameras coupled to the one or more processors. At 112, the method may include using the set of outward-facing cameras to capture users' status to evaluate engagement. At 114, the method may include receiving responses from the set of users. At 116, the method may include analyzing the set of users' status.

In some embodiments, at 118, the method may include loading a corresponding file of the set of files for a particular person in the set of users when the system may be focusing on the particular person of the set of users. At 120, the method may include using tree-based or rule-based strategy to decide responses to the responses from the set of users. At 122, the method may include checking the completion status of the set of goals in real-time.

In some embodiments, the artificial intelligence system may comprise an artificial intelligence engine. An artificial intelligence engine may be configured to actively drive the conversations. The set of goals may be related to the conversations. The conversations may relate to any of processes of meetings, sales, meditation, teaching, consulting, training, and mental health treatment. An artificial intelligence engine in the artificial intelligence system may be coupled to the one or more processors and a server.

In some embodiments, the artificial intelligence engine may be trained by human experts in the field. A virtual agent may be configured to be displayed in LED/OLED displays, Android/iOS tablets, Laptops/PCs, smartphones, or VR/AR goggles. A set of multi-layer info panels coupled to the one or more processors may be configured to overlay graphics on top of the virtual agent. The visual agent may be configured to be displayed with an appearance of a real human or a humanoid or a cartoon character.

In some embodiments, the virtual agent's gender, age and ethnicity may be determined by the artificial Intelligence engine's analysis on input from the set of users. The visual agent may be configured to be displayed in full body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. The visual agent may be configured to chat with multiple persons within the set of users simultaneously. Profile and chatting content of each person of the set of users may be configured to be recorded and memorized separately via a set of files in local or cloud databases. The chatting content of each person of the set of users may be configured to be categorized and labelled with different level of privacy.

In some embodiments, the different level of privacy may be determined by the scenarios and the decisions of the each person who may be owner of the chatting content. The system may update recorded memory for each person of the set of users instantly. The AI engine may be configured to use public contents may cross the multiple persons of the set of users. The AI engine may be configured to talk privately with a single user of the set of users when disclosing private level content.

In some embodiments, the AI engine may be configured to ask permission from another user of the users during multiple-person conversation to disclose certain private contents. The AI engine may be configured to update the memory, recording, labels after each conversation for each identified user of the set of users. The list of questions may be customized for the set of users. A set of touch screens coupled to the one or more processors may be configured to allow the set of users to interact with the virtual agent by hand.

In some embodiments, and decide the response or trigger topics and contents of the conversations. The responses may comprise voice, facial expressions, sign language, motion, poses and gestures. The set of users' status may comprise psychological status, emotion, and insights. The AI engine may be configured to shift to another file of the set of files when the AI engine may be set to shift focus to a different person of the set of users.

In some embodiments, if the set of goals may be not reached, the AI engine may be configured to continue the conversations. If the set of goals may be reached, the AI engine may be configured to suggest to end the conversations. If the set of users' responses may be not positively driving, the AI engine may be configured to revise the set of goals during the conversation by mitigating the unsatisfied responses from the set of users.

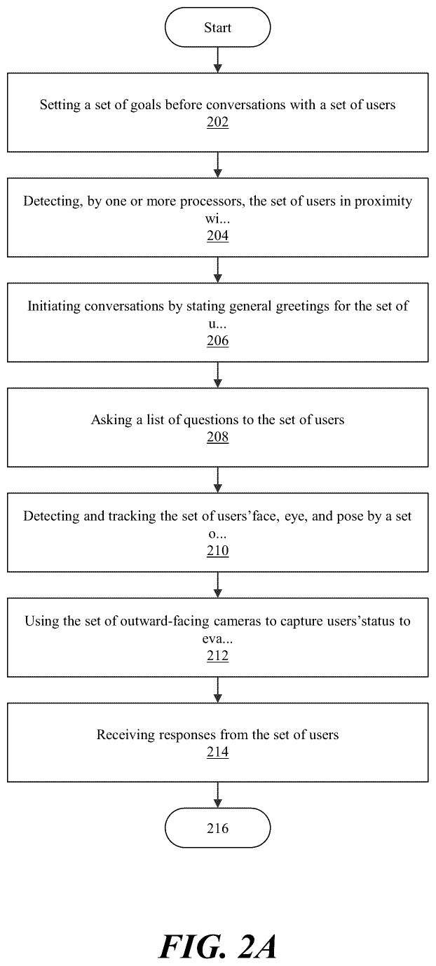

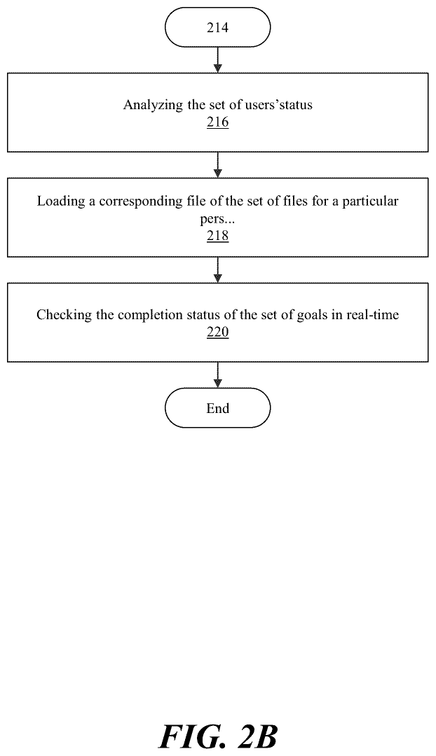

FIGS. 2A to 2B are flowcharts that describe a method for providing services for one or more persons, according to some embodiments of the present disclosure. In some embodiments, at 202, the method may include setting a set of goals before conversations with a set of users. At 204, the method may include detecting, by one or more processors, the set of users in proximity with the artificial intelligence. At 206, the method may include initiating conversations by stating general greetings for the set of users. At 208, the method may include asking a list of questions to the set of users.

In some embodiments, at 210, the method may include detecting and tracking the set of users' face, eye, and pose by a set of outward-facing cameras coupled to the one or more processors. At 212, the method may include using the set of outward-facing cameras to capture users' status to evaluate engagement. At 214, the method may include receiving responses from the set of users. At 216, the method may include analyzing the set of users' status. At 218, the method may include loading a corresponding file of the set of files for a particular person in the set of users when the system may be focusing on the particular person of the set of users. At 220, the method may include checking the completion status of the set of goals in real-time.

In some embodiments, the artificial intelligence system may comprise an artificial intelligence engine. An artificial intelligence engine may be configured to actively drive the conversations. The set of goals may be related to the conversations. The conversations may relate to any of processes of sales, meditation, teaching, consulting, training, and mental health treatment. An artificial intelligence engine in the artificial intelligence system may be coupled to the one or more processors and a server.

In some embodiments, the artificial intelligence engine may be trained by human experts in the field. A virtual agent may be configured to be displayed in LED/OLED displays, Android/iOS tablets, Laptops/PCs, smartphones, or VR/AR goggles. A set of multi-layer info panels coupled to the one or more processors may be configured to overlay graphics on top of the virtual agent. The visual agent may be configured to chat with multiple persons within the set of users simultaneously.

In some embodiments, profile and chatting content of each person of the set of users may be configured to be recorded and memorized separately via a set of files in local or cloud databases. The chatting content of each person of the set of users may be configured to be categorized and labelled with different level of privacy. The different level of privacy may be determined by the scenarios and the decisions of the each person who may be owner of the chatting content.

In some embodiments, the system may update recorded memory for each person of the set of users instantly. The AI engine may be configured to freely use public contents may cross the multiple persons of the set of users. The AI engine may be configured to talk privately with a single user of the set of users when disclosing private level content. The AI engine may be configured to ask permission from another user of the users during multiple-person conversation to disclose certain private contents.

In some embodiments, the AI engine may be configured to update the memory, recording, labels after each conversation for each identified user of the set of users. The list of questions may be customized for the set of users. A set of touch screens coupled to the one or more processors may be configured to allow the set of users to interact with the virtual agent by hand. And decide the response or trigger topics and contents of the conversations.

In some embodiments, the responses may comprise voice, facial expressions, sign language, motion, poses and gestures. The set of users' status may comprise psychological status, emotion, and insights. The AI engine may be configured to shift to another file of the set of files when the AI engine may be set to shift focus to a different person of the set of users. If the set of goals may be not reached, the AI engine may be configured to continue the conversations. If the set of goals may be reached, the AI engine may be configured to suggest to end the conversations. If the set of users' responses may be not positively driving, the AI engine may be configured to revise the set of goals during the conversation by mitigating the unsatisfied responses from the set of users.

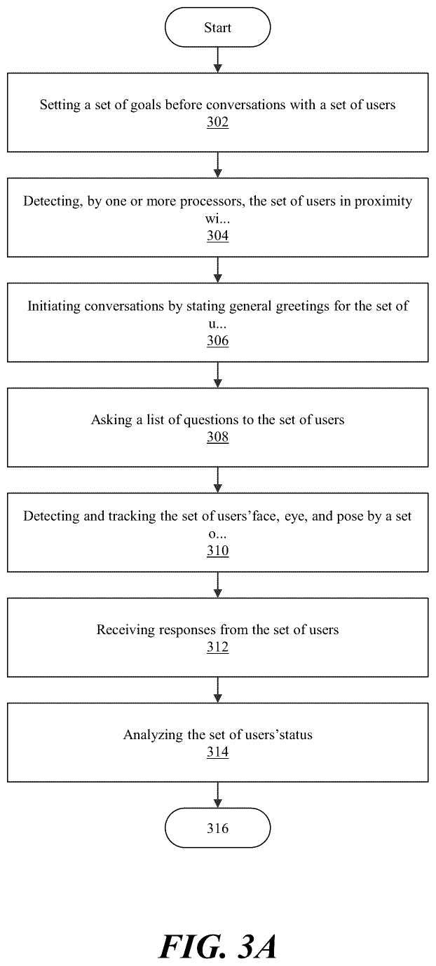

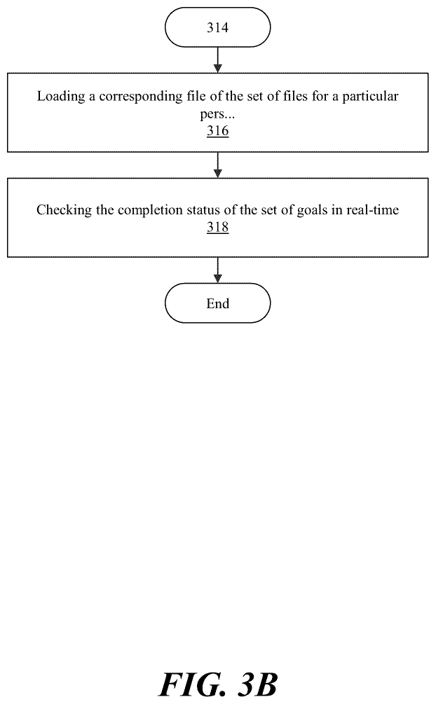

FIGS. 3A to 3B are flowcharts that describe a method for providing meeting services for one or more persons, according to some embodiments of the present disclosure. In some embodiments, at 302, the method may include setting a set of goals before conversations with a set of users. At 304, the method may include detecting, by one or more processors, the set of users in proximity with the artificial intelligence. At 306, the method may include initiating conversations by stating general greetings for the set of users. At 308, the method may include asking a list of questions to the set of users.

In some embodiments, at 310, the method may include detecting and tracking the set of users' face, eye, and pose by a set of outward-facing cameras coupled to the one or more processors. At 312, the method may include receiving responses from the set of users. At 314, the method may include analyzing the set of users' status. At 316, the method may include loading a corresponding file of the set of files for a particular person in the set of users when the system may be focusing on the particular person of the set of users. At 318, the method may include checking the completion status of the set of goals in real-time.

In some embodiments, the artificial intelligence system may comprise an artificial intelligence engine. An artificial intelligence engine may be configured to actively drive the conversations. The set of goals may be related to the conversations. The conversations may relate to meetings. An artificial intelligence engine in the artificial intelligence system may be coupled to the one or more processors and a server. The artificial intelligence engine may be trained by human experts in the field.

In some embodiments, a virtual agent may be configured to be displayed in LED/OLED displays, Android/iOS tablets, Laptops/PCs, smartphones, or VR/AR goggles. A set of multi-layer info panels coupled to the one or more processors may be configured to overlay graphics on top of the virtual agent. The visual agent may be configured to chat with multiple persons within the set of users simultaneously. Profile and chatting content of each person of the set of users may be configured to be recorded and memorized separately via a set of files in local or cloud databases.

In some embodiments, the chatting content of each person of the set of users may be configured to be categorized and labelled with different level of privacy. The different level of privacy may be determined by the scenarios and the decisions of the each person who may be owner of the chatting content. The system may update recorded memory for each person of the set of users instantly. The AI engine may be configured to freely use public contents may cross the multiple persons of the set of users.

In some embodiments, the AI engine may be configured to talk privately with a single user of the set of users when disclosing private level content. The AI engine may be configured to ask permission from another user of the users during multiple-person conversation to disclose certain private contents. The AI engine may be configured to update the memory, recording, labels after each conversation for each identified user of the set of users.

In some embodiments, the list of questions may be customized for the set of users. A set of touch screens coupled to the one or more processors may be configured to allow the set of users to interact with the virtual agent by hand. The responses may comprise voice, facial expressions, sign language, motion, poses and gestures. The set of users' status may comprise psychological status, emotion, and insights. The AI engine may be configured to shift to another file of the set of files when the AI engine may be set to shift focus to a different person of the set of users.

In some embodiments, if the set of goals may be not reached, the AI engine may be configured to continue the conversations. If the set of goals may be reached, the AI engine may be configured to suggest to end the conversations. If the set of users' responses may be not positively driving, the AI engine may be configured to revise the set of goals during the conversation by mitigating the unsatisfied responses from the set of users.

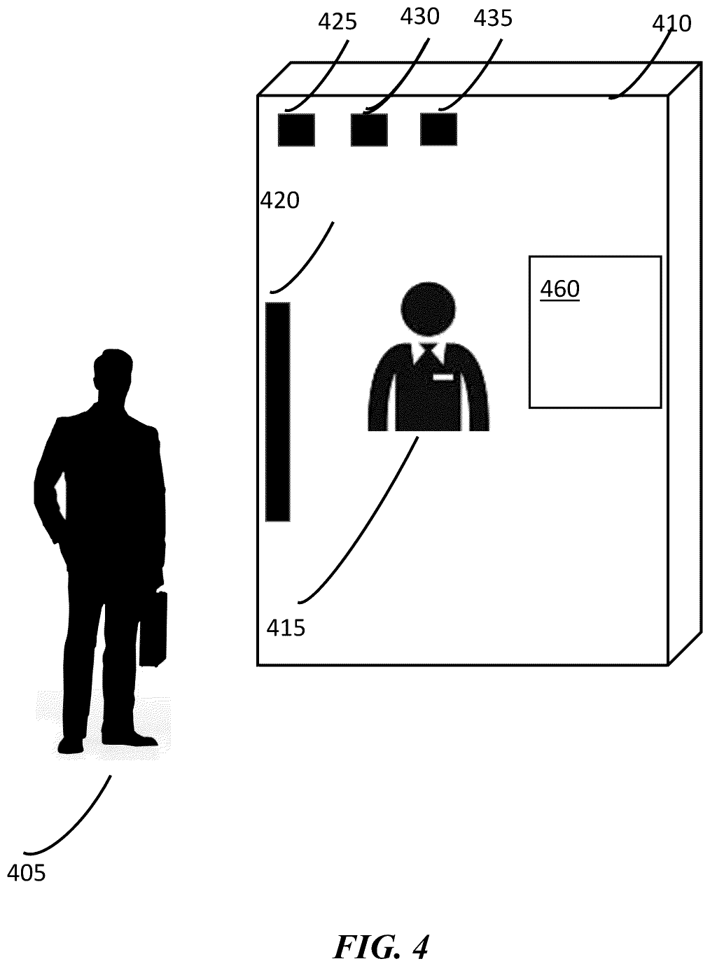

FIG. 4 is a diagram showing an example that describes a first example of a method for providing services for one or more persons, according to some embodiments of the present disclosure.

In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual assistant 415 is active on the smart display 410. In some embodiments, a visual working agenda 460 is shown on the smart display 410. In some embodiments, user 405 can approach the smart display 410 and initiate and complete the intended business with the visual assistant 415 by the methods described in FIG. 1-FIG. 3. In some embodiments, interactive panel 420 is coupled to a central processor. In some embodiments, interactive panel 420 is coupled to a server via a wireless link. In some embodiments, user 405 can interact with the visual assistant 415 via camera 425, sensor 430 and microphone 435 using methods described in FIG. 1-FIG. 3, with the help of interactive panel 420. In some embodiments, user 405 can choose what language to be used. In some embodiments, other users can use this service descripted in this paragraph.

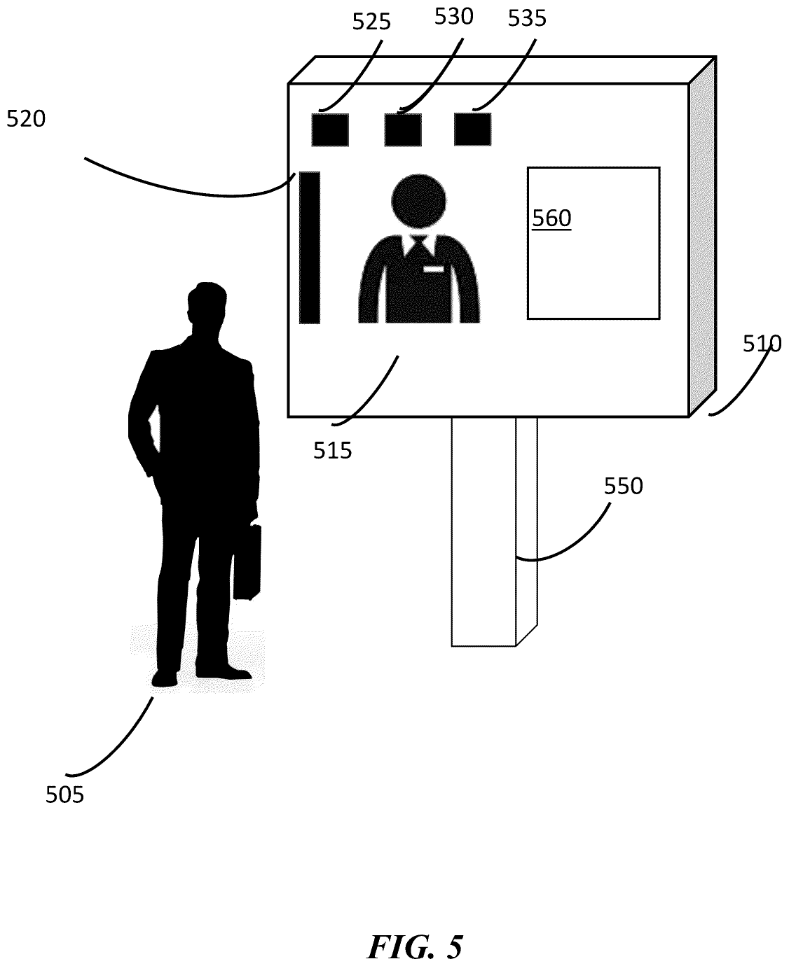

FIG. 5 is a diagram showing a second example of a method for providing services for one or more persons, according to some embodiments of the present disclosure.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530, and microphone 535 are attached to the smart display 510. In some embodiments, a support column 550 is attached to the smart display 510. In some embodiments, an artificial intelligence visual assistant 515 is active on the smart display 510. In some embodiments, a visual working agenda 560 is shown on the smart display 510. In some embodiments, user 505 can approach the smart display 510 and initiate and complete the business process with the visual assistant 515 by the methods described in FIG. 1-FIG. 3. In some embodiments, interactive panel 520 is coupled to a central processor. In some embodiments, interactive panel 520 is coupled to a server via a wireless link. In some embodiments, user 505 can interact with the visual assistant 515 via camera 525, sensor 530 and microphone 535 using methods described in FIG. 1-FIG. 3, with the help of interactive panel 520. In some embodiments, user 505 can choose what language to be used. In some embodiments, other users can use this service descripted in this paragraph.

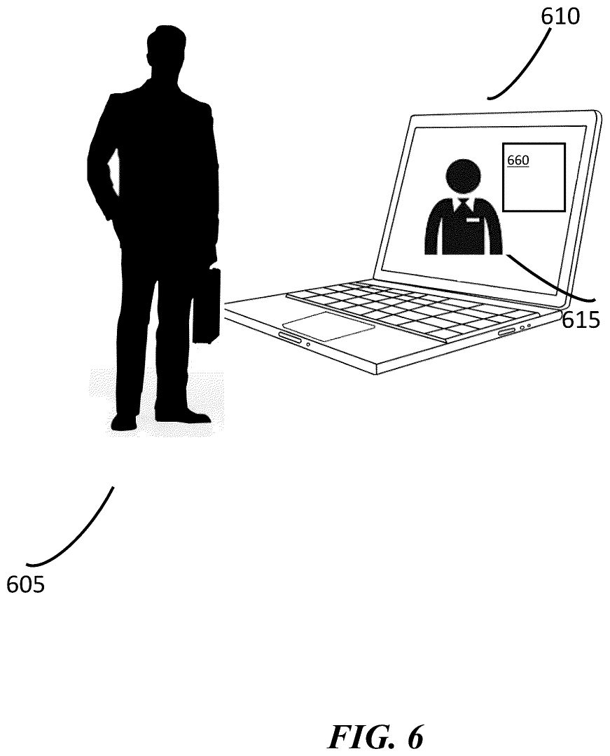

FIG. 6 is a diagram showing a third example of a method for providing services for one or more persons, according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer or a tablet computer. In some embodiments, a camera, sensor, and microphone are attached to the smart display 610. In some embodiments, an artificial intelligence visual assistant 615 is active on the smart display 610. In some embodiments, a visual working agenda 660 is shown on the smart display 610. In some embodiments, user 605 can approach the smart display 610 and initiate and complete the business process with the visual assistant 615 by the methods described in FIG. 1-FIG. 3. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 3, with the help of the keyboard. In some embodiments, user 605 can choose what language to use. In some embodiments, other users can use this service descripted in this paragraph.

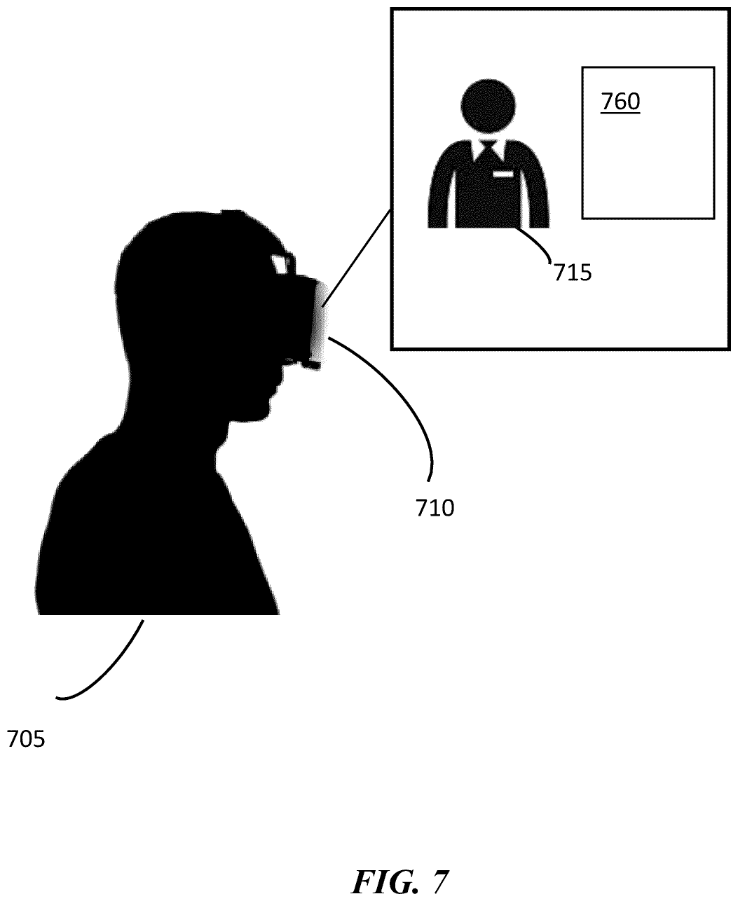

FIG. 7 is a diagram showing a fourth example of a method for providing services for one or more persons, according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 is active on the VR or AR device 710. In some embodiments, a visual working agenda 760 is shown on the VR or AR 710. In some embodiments, user 705 can initiate and complete the business process with the visual assistant 705 via the VR or AR device 715 by the methods described in FIG. 1-FIG. 3. In some embodiments, an interactive panel is coupled to a central processor. In some embodiments, an interactive panel is coupled to a server via a wireless link. In some embodiments, the user 705 can choose what language to use. In some embodiments, other users can use this service descripted in this paragraph.

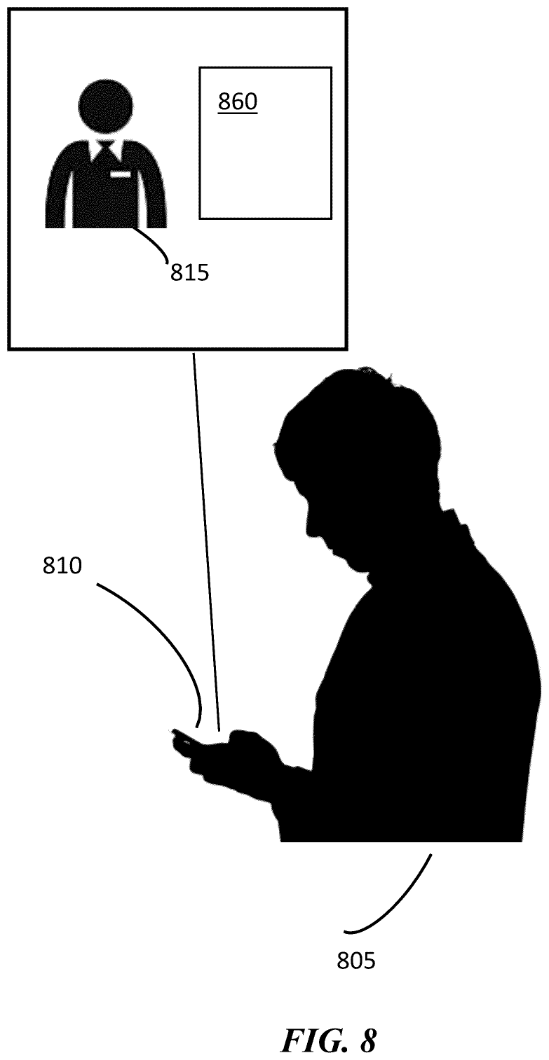

FIG. 8 is a diagram showing a fifth example of a method for providing services for one or more persons, according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 is active on the smartphone device 810. In some embodiments, a visual working agenda 860 is shown on the smartphone device 810. In some embodiments, user 805 can initiate and complete the business process with the visual assistant 815 via smartphone device 810 by the methods described in FIG. 1-FIG. 3. In some embodiments, an interactive panel is coupled to a central processor. In some embodiments, interactive panel is coupled to a server via a wireless link. In some embodiments, the user 805 can choose what language to be used. In some embodiments, other users can use this service descripted in this paragraph.

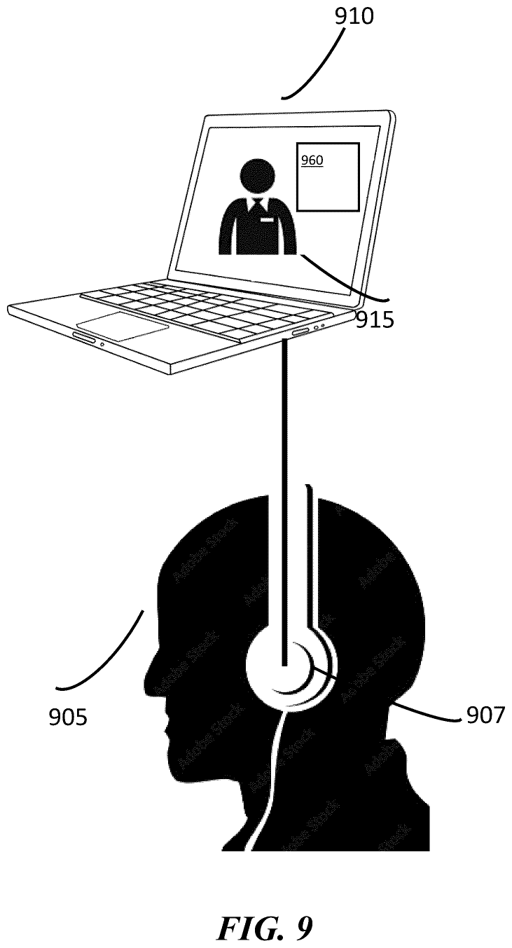

FIG. 9 is a diagram showing a sixth example of a method for providing services for one or more persons, according to some embodiments of the present disclosure.

In some embodiments, a user 905 has a brain-computer interface. In some embodiments, the user 905 may wear a headset 907 that can detect and translate the electric signal from the brain and communicate with the computer or other devices. The computer 910 or other devices are connected with a cable or wire to the headset. In some embodiments, a processor and a server are connected to the computer 910. In some embodiments, an interactive keyboard is connected to the computer 910. In some embodiments, an AI visual assistant 915 is active on the computer 910. In some embodiments, a visual working agenda 960 is shown on the computer 910. In some embodiments, user 905 can initiate and complete the business process with the visual assistant 905 via the computer 915 by the methods described in FIG. 1-FIG. 3. In some embodiments, an interactive panel is coupled to a central processor. In some embodiments, an interactive panel is coupled to a server via a wireless link. In some embodiments, the user 905 can choose what language to use. In some embodiments, other users can use this service descripted in this paragraph.

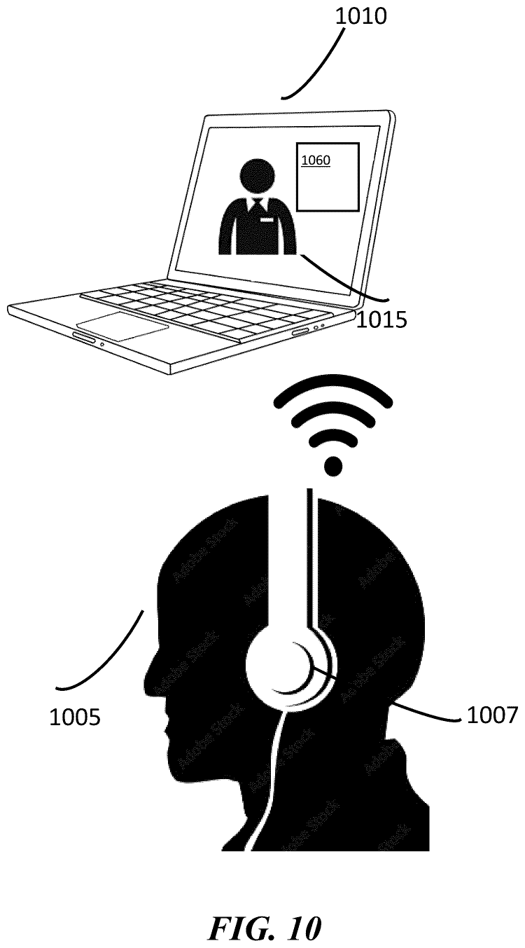

FIG. 10 is a diagram showing a seventh example of a method for providing services for one or more persons, according to some embodiments of the present disclosure.

In some embodiments, a user 1005 has a brain-computer interface. In some embodiments, the user 1005 may wear a headset 1007 that can detect and translate the electric signal from the brain and communicate with the computer or other devices. The computer 1010 or other devices are connected with wireless means to the headset. In some embodiments, a processor and a server are connected to the computer 1010. In some embodiments, an interactive keyboard is connected to the computer 1010. In some embodiments, an AI visual assistant 1015 is active on the computer 1010. In some embodiments, a visual working agenda 1060 is shown on the computer 1010. In some embodiments, user 1005 can initiate and complete the business process with the visual assistant 1005 via the computer 1015 by the methods described in FIG. 1-FIG. 3. In some embodiments, an interactive panel is coupled to a central processor. In some embodiments, an interactive panel is coupled to a server via a wireless link. In some embodiments, the user 1005 can choose what language to use. In some embodiments, other users can use this service descripted in this paragraph.

1. A method for providing services for one or more persons with an artificial intelligence system within an area, the method comprising:
setting a set of goals before conversations with a set of users, wherein the artificial intelligence system comprises an artificial intelligence engine, wherein an artificial intelligence engine is configured to actively drive the conversations, wherein the set of goals are related to the conversations, wherein the conversations may relate to any of processes of meetings, sales, meditation, teaching, consulting, training, and mental health treatment;
detecting, by one or more processors, the set of users in proximity with the artificial intelligence, wherein an artificial intelligence engine in the artificial intelligence system is coupled to the one or more processors and a server, wherein the artificial intelligence engine is trained by human experts in the field, wherein a virtual agent is configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual agent, wherein the visual agent is configured to be displayed with an appearance of a real human or a humanoid or a cartoon character, wherein the virtual agent's gender, age and ethnicity is determined by the artificial Intelligence engine's analysis on input from the set of users, wherein the visual agent is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages, wherein the visual agent is configured to chat with multiple persons within the set of users simultaneously, wherein profile and chatting content of each person of the set of users are configured to be recorded and memorized separately via a set of files in local or cloud databases, wherein the chatting content of each person of the set of users is configured to be categorized and labelled with different level of privacy, wherein the different level of privacy is determined by the scenarios and the decisions of the each person who is owner of the chatting content, wherein the system may update recorded memory for each person of the set of users instantly, wherein the AI engine is configured to use public contents cross the multiple persons of the set of users, wherein the AI engine is configured to talk privately with a single user of the set of users when disclosing private level content, wherein the AI engine is configured to ask permission from another user of the users during multiple-person conversation to disclose certain private contents, wherein the AI engine is configured to update the memory, recording, labels after each conversation for each identified user of the set of users;
initiating conversations by stating general greetings for the set of users;
asking a list of questions to the set of users, wherein the list of questions may be customized for the set of users;
detecting and tracking the set of users' face, eye, and pose by a set of outward-facing cameras coupled to the one or more processors, wherein a set of touch screens coupled to the one or more processors is configured to allow the set of users to interact with the virtual agent by hand;
using the set of outward-facing cameras to capture users' status to evaluate engagement and decide the response or trigger topics and contents of the conversations;
receiving responses from the set of users, wherein the responses comprise voice, facial expressions, sign language, motion, poses and gestures;
analyzing the set of users' status, wherein the set of users' status comprise psychological status, emotion, and insights;
loading a corresponding file of the set of files for a particular person in the set of users when the system is focusing on the particular person of the set of users, wherein the AI engine is configured to shift to another file of the set of files when the AI engine is set to shift focus to a different person of the set of users;
using tree-based or rule-based strategy to decide responses to the responses from the set of users; and
checking the completion status of the set of goals in real-time, wherein if the set of goals is not reached, the AI engine is configured to continue the conversations, wherein if the set of goals is reached, the AI engine is configured to suggest to end the conversations, wherein if the set of users' responses are not positively driving, the AI engine is configured to revise the set of goals during the conversation by mitigating the unsatisfied responses from the set of users.

2. A method for providing services for one or more persons with an artificial intelligence system within an area, the method comprising:
setting a set of goals before conversations with a set of users, wherein the artificial intelligence system comprises an artificial intelligence engine, wherein an artificial intelligence engine is configured to actively drive the conversations, wherein the set of goals are related to the conversations, wherein the conversations may relate to any of processes of sales, meditation, teaching, consulting, training, and mental health treatment;
detecting, by one or more processors, the set of users in proximity with the artificial intelligence, wherein an artificial intelligence engine in the artificial intelligence system is coupled to the one or more processors and a server, wherein the artificial intelligence engine is trained by human experts in the field, wherein a virtual agent is configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual agent, wherein the visual agent is configured to chat with multiple persons within the set of users simultaneously, wherein profile and chatting content of each person of the set of users are configured to be recorded and memorized separately via a set of files in local or cloud databases, wherein the chatting content of each person of the set of users is configured to be categorized and labelled with different level of privacy, wherein the different level of privacy is determined by the scenarios and the decisions of the each person who is owner of the chatting content, wherein the system may update recorded memory for each person of the set of users instantly, wherein the AI engine is configured to freely use public contents cross the multiple persons of the set of users, wherein the AI engine is configured to talk privately with a single user of the set of users when disclosing private level content, wherein the AI engine is configured to ask permission from another user of the users during multiple-person conversation to disclose certain private contents, wherein the AI engine is configured to update the memory, recording, labels after each conversation for each identified user of the set of users;
initiating conversations by stating general greetings for the set of users;
asking a list of questions to the set of users, wherein the list of questions may be customized for the set of users;
detecting and tracking the set of users' face, eye, and pose by a set of outward-facing cameras coupled to the one or more processors, wherein a set of touch screens coupled to the one or more processors is configured to allow the set of users to interact with the virtual agent by hand;
using the set of outward-facing cameras to capture users' status to evaluate engagement and decide the response or trigger topics and contents of the conversations;
receiving responses from the set of users, wherein the responses comprise voice, facial expressions, sign language, motion, poses and gestures;
analyzing the set of users' status, wherein the set of users' status comprise psychological status, emotion, and insights;
loading a corresponding file of the set of files for a particular person in the set of users when the system is focusing on the particular person of the set of users, wherein the AI engine is configured to shift to another file of the set of files when the AI engine is set to shift focus to a different person of the set of users; and
checking the completion status of the set of goals in real-time, wherein if the set of goals is not reached, the AI engine is configured to continue the conversations, wherein if the set of goals is reached, the AI engine is configured to suggest to end the conversations, wherein if the set of users' responses are not positively driving, the AI engine is configured to revise the set of goals during the conversation by mitigating the unsatisfied responses from the set of users.

3. A method for providing meeting services for one or more persons with an artificial intelligence system within an area, the method comprising:
setting a set of goals before conversations with a set of users, wherein the artificial intelligence system comprises an artificial intelligence engine, wherein an artificial intelligence engine is configured to actively drive the conversations, wherein the set of goals are related to the conversations, wherein the conversations may relate to meetings;
detecting, by one or more processors, the set of users in proximity with the artificial intelligence, wherein an artificial intelligence engine in the artificial intelligence system is coupled to the one or more processors and a server, wherein the artificial intelligence engine is trained by human experts in the field, wherein a virtual agent is configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual agent, wherein the visual agent is configured to chat with multiple persons within the set of users simultaneously, wherein profile and chatting content of each person of the set of users are configured to be recorded and memorized separately via a set of files in local or cloud databases, wherein the chatting content of each person of the set of users is configured to be categorized and labelled with different level of privacy, wherein the different level of privacy is determined by the scenarios and the decisions of the each person who is owner of the chatting content, wherein the system may update recorded memory for each person of the set of users instantly, wherein the AI engine is configured to freely use public contents cross the multiple persons of the set of users, wherein the AI engine is configured to talk privately with a single user of the set of users when disclosing private level content, wherein the AI engine is configured to ask permission from another user of the users during multiple-person conversation to disclose certain private contents, wherein the AI engine is configured to update the memory, recording, labels after each conversation for each identified user of the set of users;
initiating conversations by stating general greetings for the set of users;
asking a list of questions to the set of users, wherein the list of questions may be customized for the set of users;
detecting and tracking the set of users' face, eye, and pose by a set of outward-facing cameras coupled to the one or more processors, wherein a set of touch screens coupled to the one or more processors is configured to allow the set of users to interact with the virtual agent by hand;
receiving responses from the set of users, wherein the responses comprise voice, facial expressions, sign language, motion, poses and gestures;
analyzing the set of users' status, wherein the set of users' status comprise psychological status, emotion, and insights;
loading a corresponding file of the set of files for a particular person in the set of users when the system is focusing on the particular person of the set of users, wherein the AI engine is configured to shift to another file of the set of files when the AI engine is set to shift focus to a different person of the set of users; and
checking the completion status of the set of goals in real-time, wherein if the set of goals is not reached, the AI engine is configured to continue the conversations, wherein if the set of goals is reached, the AI engine is configured to suggest to end the conversations, wherein if the set of users' responses are not positively driving, the AI engine is configured to revise the set of goals during the conversation by mitigating the unsatisfied responses from the set of users.
